(19) United States
(12) Patent Application Publication
(10) Pub. No.: US 2010/0040786 A1
(43) Pub. Date: Feb. 18, 2010

(54) PROCESS FOR SEALING MICRO PORES OF MICRO-ARC OXIDE FILMS

(75) Inventors: FENG-YUEN DAI, Shindian (TW); CHWAN-HWA CHIANG, Shindian (TW); YUNG-TA LO, Shindian (TW); CHI-CHUANG HO, Shindian (TW); WEI LIU, Shenzhen City (CN); XU-FENG AO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/478,020

(22) Filed: Jun. 4, 2009

(30) Foreign Application Priority Data
Aug. 14, 2008 (CN) 200810303802.4

(51) Int. Cl. B05D 3/12; B05D 1/18; B05D 1/02

(52) U.S. Cl. 427/355; 427/435; 427/421.1

(57) ABSTRACT

A process for sealing micro pores of micro-arc oxide film is disclosed in the present disclosure. The process may comprise the following steps: providing a piece of metal having a micro-arc oxide film; preparing a solution including ethyl silicate to make a sealing agent; dipping the metal in the sealing agent to form a coating on the film's surface.

### CROSS-REFERENCE TO RELATED APPLICATIONS

This application is related to co-pending U.S. patent applications (Attorney Docket Nos. US20819, US23072, and US23075), all entitled “PROCESS FOR SEALING MICRO PORES OF MICRO-ARC OXIDE FILMS”. Such applications have the same assignee as the present application. The above-identified applications are incorporated herein by reference.

### BACKGROUND

1. Technical Field

The present disclosure relates to a process for sealing micro pores of micro-arc oxide films.

2. Description of Related Art

Micro-arc oxidation is a surface treatment process that oxidizes a metal's surface to form a micro-arc oxide film. Micro-arc oxide films have an attractive appearance, like ceramic, and possesses high rigidity. Micro-arc oxidation is widely applied in the field of surface decoration.

When being treated by micro-arc oxidation at a high temperature, the metal substrate discharges gas through the oxide film formed on the surface, thereby forming a plurality of micro pores in the oxide film. The micro pores should be sealed to prevent the micro-arc oxide film from being contaminated by dirt or other impurity.

A typical process for sealing micro pores of micro-arc oxide film is similar to the process for sealing micro pores of an anode oxide film. However, the micro pores of the micro-arc oxide film are different from those of the anode oxide film in terms of physical dimensions and properties. Therefore, the sealing process for the anode oxide film has poor effect on the micro-arc oxide film. In addition, this sealing process may negatively affect the appearance of the micro-arc oxide film.

Therefore, there is room for improvement within the art.

### DETAILED DESCRIPTION

A process for sealing micro pores of micro-arc oxide films is disclosed in the present disclosure. The process may comprise at least the following steps: providing a piece of metal which is formed with a micro-arc oxide film; employing a solution including ethyl silicate as a sealing agent; dipping the metal in the sealing agent to form a coating on the micro-arc oxide film. The solution may be an ethyl silicate ethanol solution, the ethanol may advantageously be absolute ethanol. The solution may further has dense ammonia and deionized water mixed therein. The volume ratio among the ethyl silicate, anhydrous ethanol, dense ammonia and deionized water is about 2˜4:25˜35:0.5˜1.5:5˜12. The solution can also has surfactant added therein to reduce the sol's surface tension in the sealing process, in order to enhance penetration ability of the sealing agent to the oxide film. The surfactant may advantageously be fluorosilicone surfactant. The fluorosilicone surfactant is in a portion of 0.02˜0.1% wt of the sealing agent. The coating formed on the oxide film has a thickness of about 3˜4.5 μm.

### Example 1

A piece of aluminum alloy coated with a micro-arc oxide film is provided. The micro-arc oxide film's surface roughness is 1.33 μm. Then, 30 ml ethyl silicate, 280 ml absolute ethanol, 10 ml dense ammonia and 80 ml deionized water are uniformly blended to form a mixture. After that, 0.08 g fluorosilicone surfactant is added into the mixture while being mixed to make a sealing agent. The sealing agent should be statically placed in the open air for 20˜30 minutes to form the solution. After the sealing agent is prepared, the metal is dipped into the sealing agent at room temperature (about 20° C.) for 10˜30 minutes. After the dipping step, the metal is taken out from the sealing agent. The extra sealing agent is then partially removed from the oxide film by a centrifugation process in a centrifuge. Then, the aluminum alloy may be baked in an oven at about 200˜300° C. for 30˜60 minutes to form a coating on the surface of the micro-arc oxide film. The surface roughness of the film changes to 1.28 μm. The coating's thickness is 3.6 μm. The oxide film's rigidity is 880 HV. The micro-arc oxide film can pass smudge resistance testing after being treated by the sealing process.

### Example 2

A piece of aluminum alloy coated with a micro-arc oxide film is provided. The micro-arc oxide film's surface roughness is 1.33 μm. Then, 35 ml ethyl silicate, 250 ml absolute ethanol, 12 ml dense ammonia and 100 ml deionized water are uniformly blended to form a mixture. After that, 0.16 g fluorosilicone surfactant is added into the mixture while being mixed to make a sealing agent. The sealing agent should be statically placed in the open air for 20˜30 minutes to form the solution. After the sealing agent is prepared, the metal is dipped in the sealing agent at room temperature (about 20° C.) for 10˜30 minutes. After the dipping step, the metal is taken out from the sealing agent. The extra sealing agent is then partially removed from the oxide film by a centrifugation process in a centrifuge. Then, the aluminum alloy may be baked in an oven at about 200˜300° C. for 30˜60 minutes to form a coating on the surface of the film. The surface roughness of the film changes to 1.29 μm. The coating's thickness is 4 μm. The oxide film's rigidity is 870 HV. The micro-arc oxide film can pass smudge resistance testing after being treated by the sealing process.

The process of sealing micro pores can also be carried out by spraying or daubing the sealing agent onto the micro-arc oxide film.

The process of sealing micro pores is fit for the micro-arc oxide film which is formed on aluminum alloy, magnesium alloy and titanium alloy.

The process of sealing micro pores of micro-arc oxide film will not affect the rigidity and the appearance of the film. It is appropriate for sealing micro pores of micro-arc oxide film.

It should be understood, however, that even though numerous characteristics and advantages of the present embodiments have been set forth in the foregoing description, together with details of functions of the embodiments, the disclosure is illustrative only, and changes may be made in detail, especially in matters of mass ratio of the sealing agent and laying or baking time within the principles of the invention to the full extent indicated by the broad general meaning of the terms in which the appended claims are expressed.

What is claimed is:

1. A process for sealing micro pores of micro-arc oxide films, comprising:
providing a metal having a micro-arc oxide film;
employing a solution including ethyl silicate as a sealing agent;
dipping the metal in the sealing agent to form a coating on the film's surface.

2. The process as claimed in claim 1, wherein the sealing agent is ethyl silicate ethanol solution, the ethanol is absolute ethanol.

3. The process as claimed in claim 2, wherein the sealing agent includes ammonia and deionized water.

4. The process as claimed in claim 3, wherein the volume ratio among the ethyl silicate, anhydrous ethanol, ammonia and deionized water is 2˜4:25˜35:0.5˜1.5:5˜12.

5. The process as claimed in claim 3, wherein the sealing agent includes fluorosilicone surfactant.

6. The process as claimed in claim 1, wherein the sealing process is carried out by dipping, spraying or daubing.

7. The process as claimed in claim 1, wherein the thickness of the coating is 3˜4.5 μm.

8. The process as claimed in claim 1, wherein the metal is selected from the group consisting of aluminum alloys, magnesium alloys and titanium alloys.
